(19) United States
(12) Patent Application Publication
(10) Pub. No.: US 2007/0164526 A1
(43) Pub. Date: Jul. 19, 2007

(54) LAWN AND GARDEN CART

(75) Inventors: THOMAS P. MARTINI, COLUMBUS, OH (US); RODGER HAYS, COLUMBUS, OH (US); MARK ZELLEFROW, COLUMBUS, OH (US); JASON MOORE, COLUMBUS, OH (US); KEN HOFFMAN, COLUMBUS, OH (US); FREDERICK FEENEY, COLUMBUS, OH (US); KEVIN L. CAHALAN, COLUMBUS, OH (US); RICHARD D. BIGGS, COLUMBUS, OH (US); TOM HAYS, COLUMBUS, OH (US); HARLAN CHARLES PEDEN III, COLUMBUS, OH (US); DALE EDWARD BAUMAN, COLUMBUS, OH (US); SEAN WESLEY SVENDSEN, COLUMBUS, OH (US)

Correspondence Address: ELEY LAW FIRM CO., 7870 OLENTANGY RIVER RD, SUITE 311, COLUMBUS, OH, 43235, US

(73) Assignee: OHIO STEEL INDUSTRIES, INC., COLUMBUS, OH (US)

(21) Appl. No.: 11/621,861

(22) Filed: Jan. 10, 2007

Related U.S. Application Data
(60) Provisional application No. 60/758,263, filed on Jan. 11, 2006.

(51) Int. Cl. B62B 1/00

(52) U.S. Cl. 280/47.26

(57) ABSTRACT

A lawn and garden cart has a frame and an axle attached to the frame. A pair of wheels are attached to the axle, each wheel being rotatably attached to an opposing end of the axle. A longitudinal tow bar is attached to the frame at a first end, the tow bar including a connector at a second distal end. The cart further includes a container having a base, a plurality of generally vertical sidewalls and an angled rear wall, the container being pivotally attached to the frame and releasably coupled to the tow bar.

This application claims priority to U.S. provisional application 60/758,263, filed Jan. 11, 2006, the contents of which are hereby incorporated by reference.

### FIELD

This invention relates to lawn and garden carts, in particular to a lawn and garden cart having a container that is selectably re-configurable to receive, organize and dispense a variety of loads placed therein.

### BACKGROUND

Various equipment and accessories for use with a lawn tractor are available in the art. In particular, lawn and garden carts are frequently used as a tool to transport large, heavy and cumbersome materials such as lawn debris, fertilizer, soil, tools and equipment. Typically, a cart includes a frame to which an open bed having a base and three or four sides is mounted. The frame is in turn supported by a pair of wheels. A tow bar with a trailer hitch connector extends outwardly from the frame for attachment to a coupling of the tractor. Once coupled, the cart can be towed about the yard by the lawn tractor to transport the materials loaded into the bed.

A drawback of current lawn and garden carts is that they have limited utility, because the bed is usable for only one task at a time. For example, if the bed is loaded with lawn debris, any tools stacked atop the debris are prone to falling out of the bed while the cart is being towed. Likewise, if tools are placed into the bed first, lawn debris cannot be loaded without covering (and possibly damaging) the tools.

Another shortcoming of current lawn and garden carts is that some objects loaded into the bed are subject to shifting while being towed. Accordingly, there is a desire to secure such objects to keep them from falling out of the bed. Previous attempts to solve this problem have involved the use of bungee cords and ropes, but these devices are difficult to reliably attach to current carts and can easily become detached as the cart is moved about.

Yet another drawback of current lawn and garden carts is that they are difficult to move by hand, the tow bar being the only available handhold. Consequently, the user is often obliged to use a lawn tractor to move the cart even though it may be more efficient to move the cart manually under some circumstances, such as when working in a small space.

There is a need for a lawn and garden cart that is selectably re-configurable for a plurality of tasks, provides means for organizing and securing various objects placed therein, and can be manually transported.

### SUMMARY

A lawn and garden cart is disclosed according to several embodiments of the present invention. The cart includes a container having a plurality of generally vertical sidewalls and an angled rear wall. The cart also includes a frame to which the container is pivotally attached. An axle attached to the frame has a pair of spaced-apart wheels rotatably attached at opposing ends to support the cart. A tow bar having a hitch connector is also attached to the frame to facilitate towing the cart with a lawn tractor. The container is selectably re-configurable with integrally-provided features comprising at least one of a shelf ledge, board ledges, divider slots, tie-down receptacles and stake receptacles. At least one of a tool bin, handle and fenders may also be attached to the container.

A lawn and garden cart is disclosed according to one aspect of the invention. The cart has a frame and an axle attached to the frame. A pair of wheels are attached to the axle, each wheel being rotatably attached to an opposing end of the axle. A longitudinal tow bar is attached to the frame at a first end, the tow bar including a connector at a second distal end. The cart further includes a container having a base, a plurality of generally vertical sidewalls and an angled rear wall, the container being pivotally attached to the frame and releasably coupled to the tow bar.

According to another aspect of the invention a lawn and garden cart comprises a frame. An axle is attached to the frame and has a pair of opposing ends. A pair of wheels are attached to the axle, each wheel being rotatably attached to an opposing end of the axle. A longitudinal tow bar is attached to the frame at a first end, the tow bar including a connector at a second distal end and a movable portion proximate the second end, the movable portion having a support member and being selectably positionable between a first stowed position and a second deployed support position. The cart also includes a container having a base, a plurality of generally vertical sidewalls and an angled rear wall, the container further comprising at least one of: an integral shelf ledge; integral, opposing board ledges; integral, opposing divider slots; integral stake receptacles; an integral tie-down receptacle; and integral tubing receptacles. The container is pivotally attached to the frame and is releasably coupled to the tow bar. In addition, the container is selectably positionable with respect to a surface beneath the cart, between a first orientation wherein the base of the container is generally parallel with the surface and a second orientation wherein the angled rear wall is in contact with the surface.

### BRIEF DESCRIPTION OF THE DRAWINGS

Further features of the inventive embodiments will become apparent to those skilled in the art to which the embodiments relate from reading the specification and claims with reference to the accompanying drawings, in which:

FIG. 1 is a perspective view of a lawn and garden cart according to an embodiment of the present invention;

FIG. 2 shows details of a container of the lawn and garden cart of FIG. 1;

FIG. 3 is a view of the underside of the lawn and garden cart of FIG. 1;

FIG. 4 shows a configuration of the lawn and garden cart of FIG. 1 with a shelf installed according to an embodiment of the present invention;

FIG. 5 shows a configuration of the lawn and garden cart of FIG. 1 with support boards installed according to an embodiment of the present invention;

FIG. 6 shows a configuration of the lawn and garden cart of FIG. 1 with divider panels installed according to an embodiment of the present invention;

FIG. 7 shows a configuration of the lawn and garden cart of FIG. 1 with stakes installed according to an embodiment of the present invention;

FIG. 8 shows a configuration of the lawn and garden cart of FIG. 1 with a canopy installed according to an embodiment of the present invention;

FIG. 9A shows the attachment of fenders and a tool bin to a container of a lawn and garden cart according to an alternate embodiment of the present invention;

FIG. 9B is an expanded view of a coupling device for the fenders and tool bin of FIG. 9A;

FIG. 10 shows fenders and a tool bin attached to a lawn and garden cart according to another alternate embodiment of the present invention;

FIG. 11 shows a support member of a lawn and garden cart being pivoted from a stowed position to a deployed support position according to an embodiment of the present invention;

FIG. 12 shows a lawn and garden cart according to still another alternate embodiment of the present invention; and

FIG. 13 shows a camouflage pattern for components of a lawn and garden cart according to an embodiment of the present invention.

### DETAILED DESCRIPTION

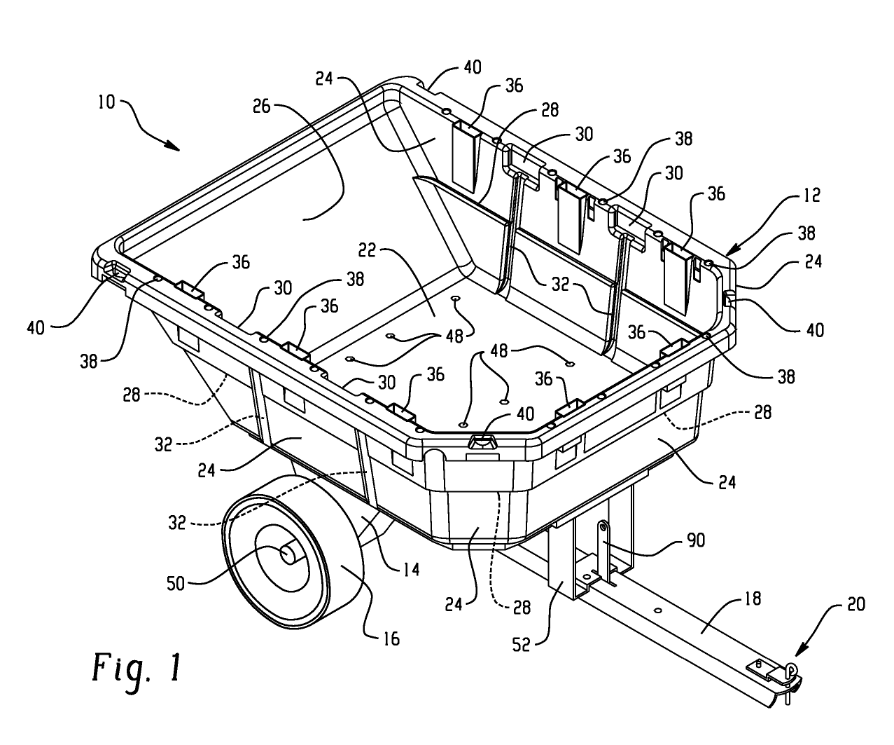

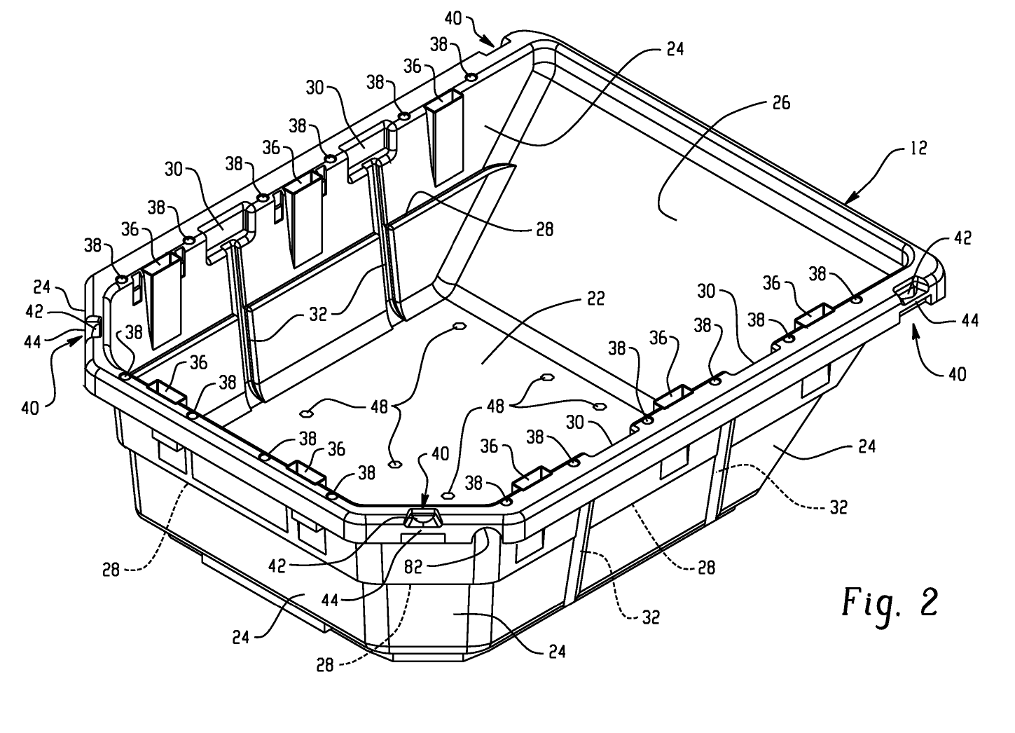

The general arrangement of a lawn and garden cart 10 is shown in FIGS. 1-3 according to an embodiment of the present invention. Cart 10 comprises a container 12 and a supporting frame 14. Frame 14 further includes a pair of wheels 16 rotatably attached thereto and a tow bar 18. A connector 20 located at a distal end of tow bar 18 facilitates coupling of cart 10 to a lawn tractor (not shown) for towing.

With continued reference to FIGS. 1-3 in combination, container 12 is generally rectangular in shape with a base 22, a plurality of generally vertical sidewalls 24, an angled rear wall 26, and a shelf ledge 28. Container 12 further includes a plurality of opposing board ledges 30, opposing divider slots 32, stake receptacles 36 and tubing receptacles 38.

Container 12 may also include a plurality of tie-down receptacles 40 located about the upper edge of the perimeter of the container. Tie-down receptacles 40 may each comprise an aperture 42 at least partially surrounded by an enclosing member 44. In use, a first end of a bungee cord or rope (not shown) may be passed through aperture 42 and/or fastened or tied to enclosing member 44. The rope or bungee cord is then extended over a load in container 12. A second end of the bungee cord or rope is likewise fastened or tied to an opposing tie-down receptacle 40 to secure the load. Four tie-down receptacles 40 are depicted proximate corners of container 12, though a greater or lesser number of tie-down receptacles could be formed in the container in various embodiments of the present invention.

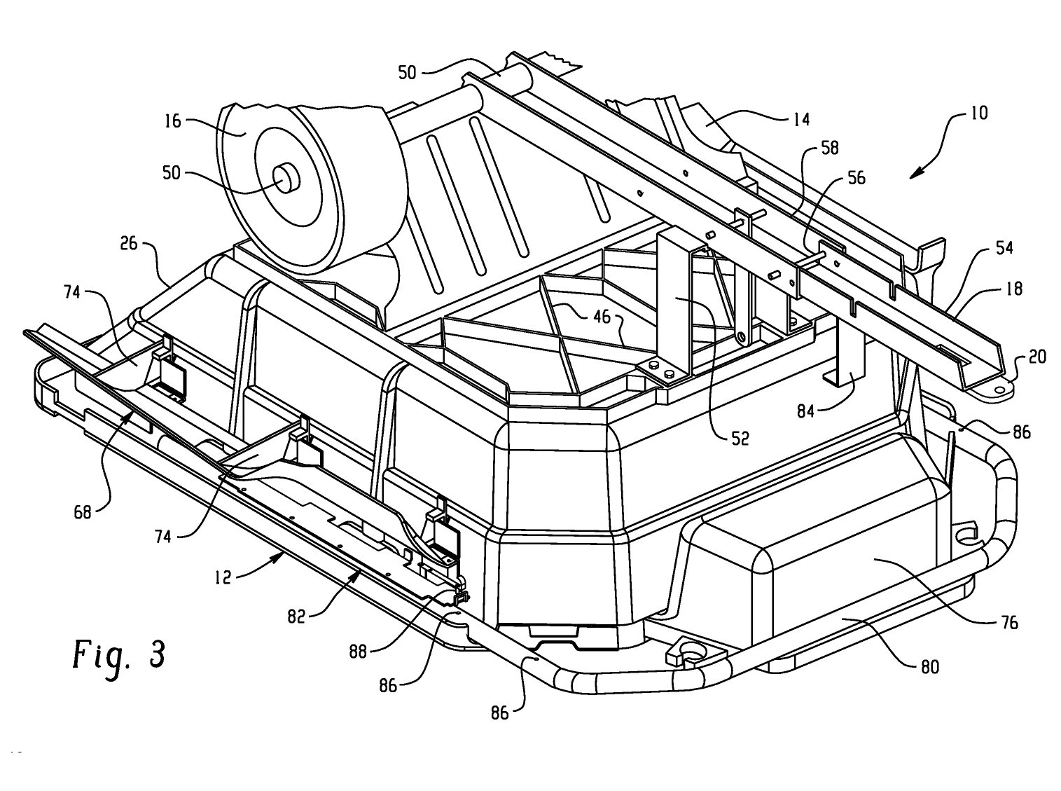

With reference to FIG. 3, container 12 may be provided with one or more integrally formed strengthening ribs 46 on a bottom portion of the container to increase the rigidity and load-bearing capacity of the container. Advantages of this configuration include relatively light weight, since ribs 46 are formed with the container. Furthermore, strengthening ribs 46 do not protrude into base 22, thus allowing the base to be generally planar and free of surface irregularities that could interfere with loading and dispensing of materials stored in container 12.

With reference again to FIGS. 1-3 in combination, container 12 may be attached to frame 14 by placing the container atop the frame and aligning a group of mounting receptacles 48 formed in base 22 with corresponding integrally-formed mounting holes (not shown) in the frame and securing the container to the frame with suitable fasteners. Example fasteners include, without limitation, hexagonal-shaped nuts and bolts having hexagonal heads. In some embodiments mounting receptacles 48 are hexagonal-shaped to captively receive the hexagonal-shaped fasteners and keep them from rotating during assembly of cart 10, thereby eliminating the need for a tool to hold the fasteners during installation. In some embodiments hexagonal-headed bolts may be inserted into mounting receptacles 48 such that the heads are captively retained by the mounting receptacles. Wing nuts may be coupled to a threaded portion of the bolts to secure container 12 to frame 14, obviating the need for tools. In addition, the fasteners installed in mounting receptacles 48 may be positioned generally flush with the base 22. This allows materials and tools to move slidably across base 22 without interference from the fasteners. For example, soil can be easily removed from base 22 using a shovel without the blade of the shovel striking the fasteners.

Container 12 may be made from any suitable material for the stresses and environmental conditions expected for cart 10. Example materials include, without limitation, plastic, metal and composites. Container 12 may be fabricated and assembled using any conventional processes, such as molding, machining, forming, welding, adhesives, fasteners, and composite lay-up. Container 12 may be finished in a color that is applied, such as paint or an electroplate, or the desired color may be molded-in using a material having the desired color.

Frame 14 provides support for container 12, which is attached thereto. Frame 14 further includes an axle 50, to which wheels 16 are rotatably attached at opposing ends. In one embodiment axle 50 may extend through one or more apertures in tow bar 18 (see FIG. 3).

In some embodiments of the present invention container 12 may be pivotally attached to frame 14 in any conventional manner. For example, container 12 may be configured by its shape and/or conventional mounting hardware, such as brackets, to pivotally attach to and pivot about axle 50. Similarly, frame 14 may include any conventional type of hinge interposed between container 12 and the frame, thereby facilitating pivotal movement of the container with respect to the frame.

Frame 14 may be made from any suitable material for the stresses and environmental conditions expected for cart 10. Example materials include, without limitation, plastic, metal and composites. Frame 14 may be fabricated and assembled using any conventional processes, such as molding, machining, forming, welding, adhesives, fasteners, and composite lay-up. Frame 14 may be finished in a color that is applied, such as paint or an electroplate, or the desired color may be molded-in using a material having the desired color.

Wheels 16 rotatably attach to axle 50 of frame 14 to facilitate transport of cart 10. Wheels 16 may be any conventional type of wheel, comprising solid or air-filled plastic or rubber tires, and may include a wheel-bearing interface with axle 50. Wheels 16 may be secured to axle 50 in any conventional manner, including bolts, screws, nuts, lugs and pins.

With reference now to FIGS. 1 and 3, tow bar 18 is generally longitudinal and is attached to frame 14 at a first end. Tow bar 18 extends outwardly from frame 14, being supported in part by a bracket 52 attached to container 12 and detachably engageable with the tow bar as depicted in FIG. 1. Tow bar 18 may be generally rectangular, having a “U” shape, or may be a closed rectangular box. In other embodiments tow bar 18 may have a generally circular shape. Tow bar 18 may be made of metal, such as steel, or from other materials such as high density plastic and composites. Tow bar 18 is attached to frame 14 in any conventional manner, such as bolts, screws, nuts, lugs and pins. In some embodiments of the present invention a movable portion 54 of tow bar 18 is configurable to be selectably secured by a pivot mechanism 56, such as a conventional pin or hinge, and pivoted with respect to a fixed portion 58 of the tow bar (see FIGS. 3, 11 and 12).

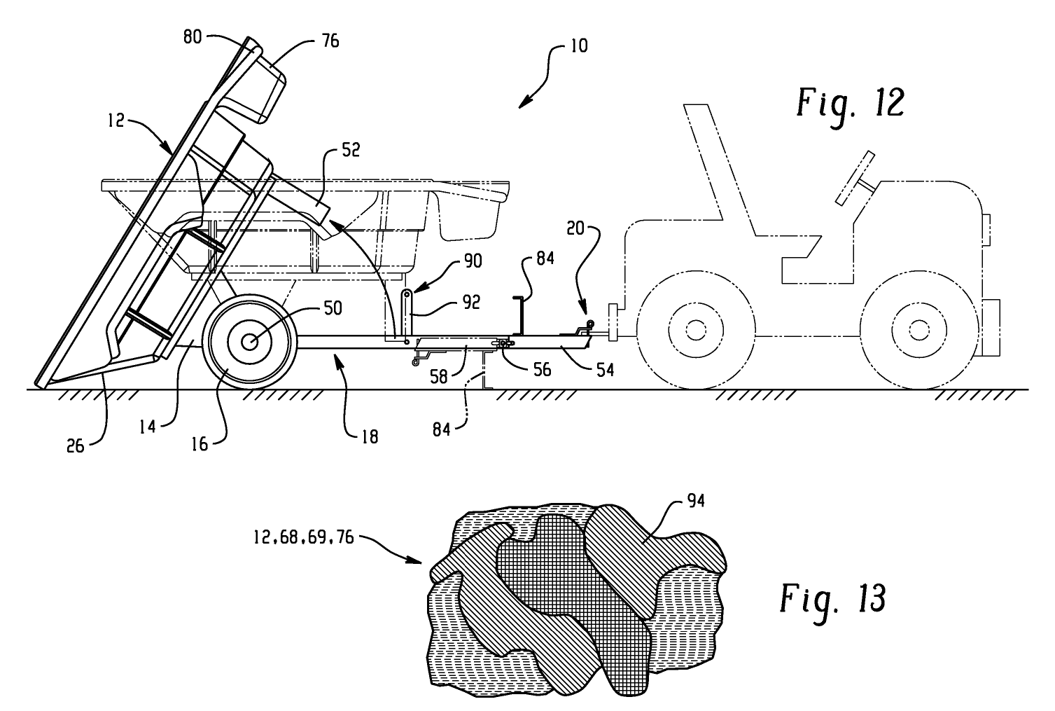

Connector 20 is located at a second end of tow bar 18 distal to frame 14 and is configured to couple cart 10 to a lawn tractor for towing (FIG. 12). Connector 20 may be of any conventional type including a ball hitch, drawbar hitch, sleeve hitch, and three-point hitch.

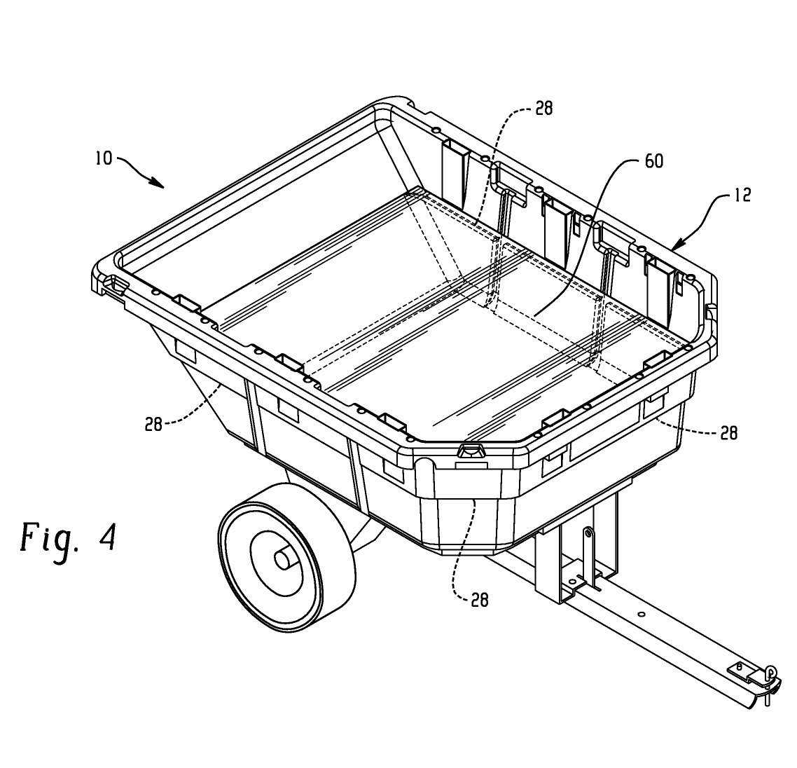

Cart 10 is selectably re-configurable for a variety of tasks. With reference to FIG. 4, in a first configuration a removable, generally planar shelf 60 of suitable size and shape may be placed into container 12, resting upon an integrally formed shelf ledge 28. Shelf 60 may be sized and shaped substantially close off container 12 as shown in FIG. 4, or may be sized and shaped to close off only a portion of the container. As can be seen from FIG. 4, with shelf 60 in place container 12 is at least partially divided horizontally into upper and lower sections, allowing a user to separate portions of the load held by the container.

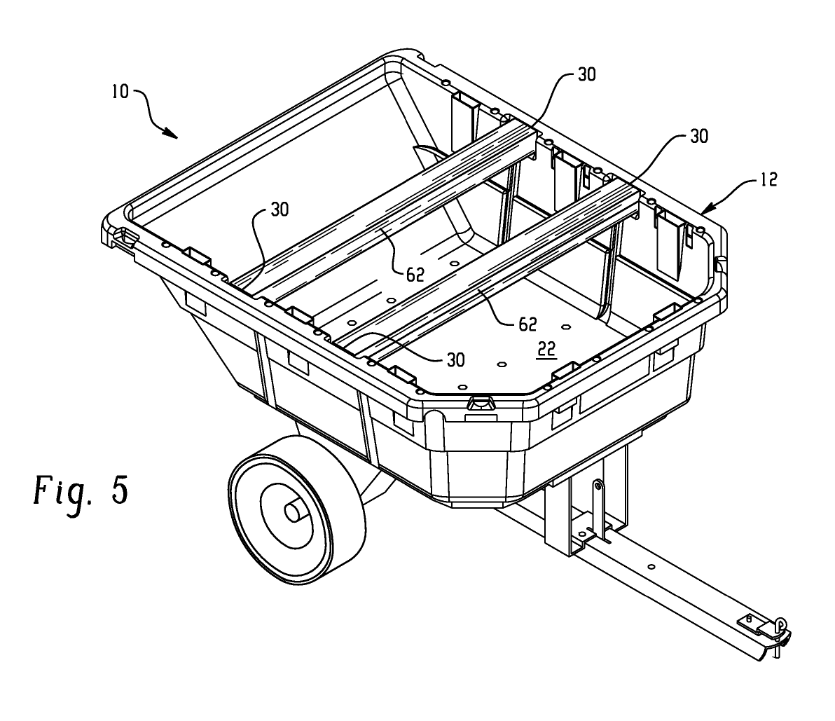

In a second configuration of cart 10, shown in FIG. 5, a plurality of removable support boards 62 such as conventional wooden “2×4” support boards of suitable length can be installed into opposing board ledges 30 that are integrally formed in container 12. With support boards 62 installed into ledges 30 various objects such as tools and large objects may be placed across the boards and spaced apart from base 22, thus allowing other objects to be placed upon the base. Two pairs of board ledges 30 are shown in FIG. 5, but a fewer or greater number may be formed in container 12 in various embodiments of the present invention.

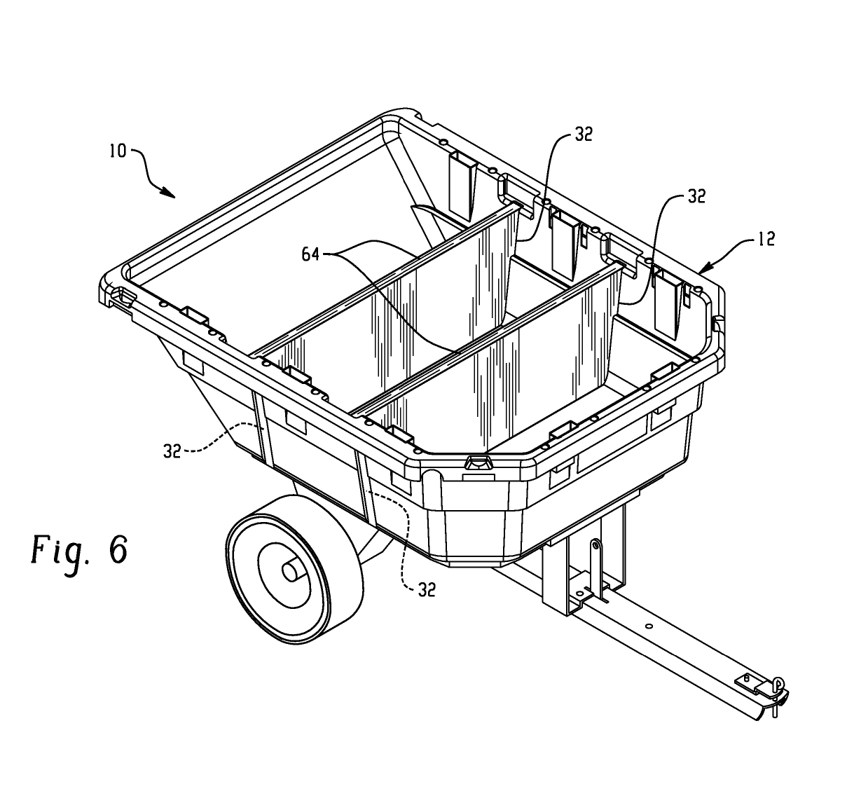

In a third configuration of cart 10, shown in FIG. 6 removable, generally planar divider panels 64 of suitable size and shape may be slidably inserted into opposing divider slots 32 that are integrally formed in container 12. With one or more divider panels 64 in place cart 10 may be partially or entirely divided vertically into two or more sections. Two pairs of divider slots 32 are shown in FIG. 6, but a fewer or greater number may be formed in various embodiments of the present invention.

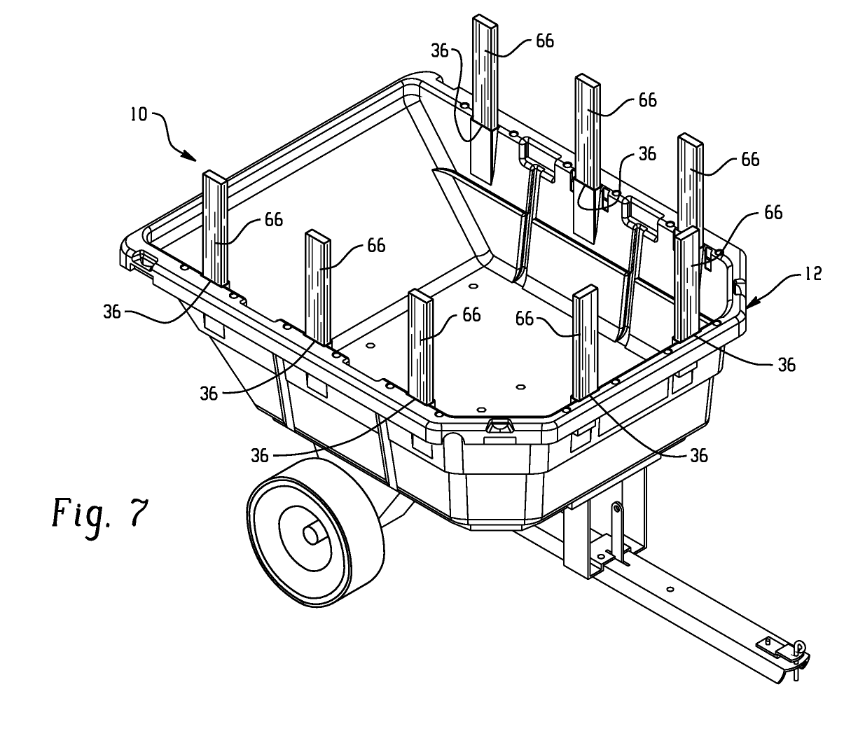

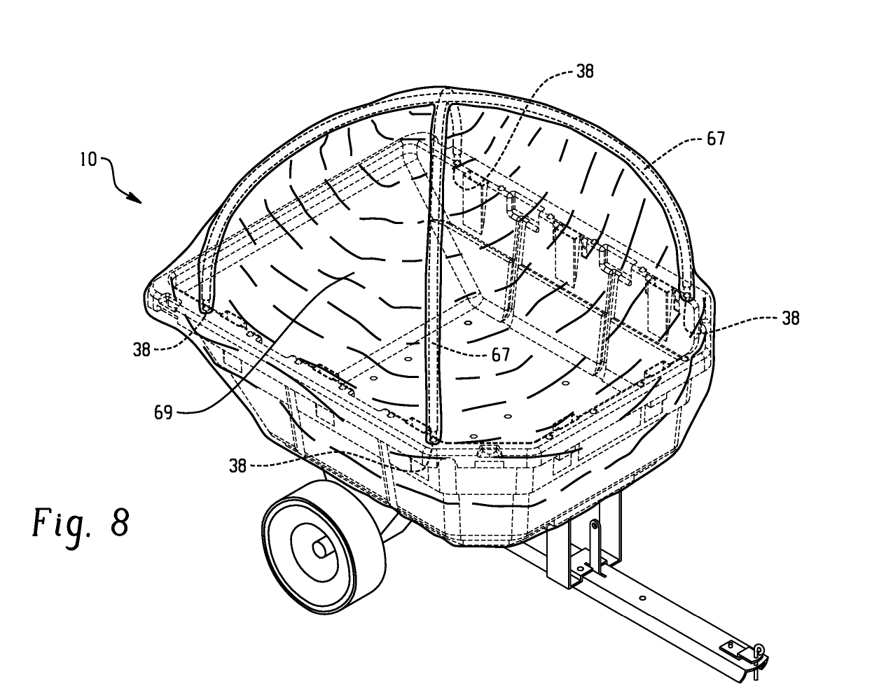

In a fourth configuration of cart 10, shown in FIG. 7, one or more removable stakes 66 of suitable size, shape and length may be inserted into corresponding stake receptacles 36 integrally formed in container 12. Each stake receptacle 36 is configured to receive and retain a stake. A plurality of stakes 66 can be installed into corresponding stake receptacles 36, increasing the effective height of container 12 and allowing cart 10 to carry a taller load. Eight stake receptacles 36 are shown in FIG. 7, though a greater or lesser number could be formed in container 12 in various embodiments of the present invention.

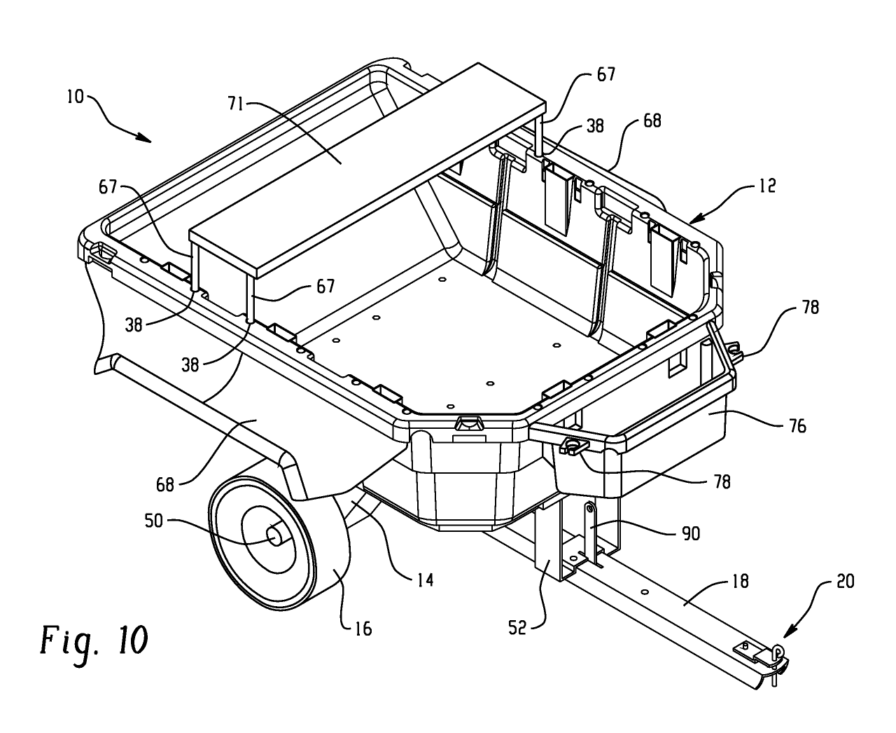

With reference to FIG. 10, in a fifth configuration of cart 10 at least a portion of a plurality of tubing receptacles 38 integrally formed in container 12 may be used to receive a framework of removable rigid or flexible tubing 67 to support a removable cover or canopy 69. Tubing receptacles 38 may likewise be used to receive removable tubular-shaped connectors for accessories 71 such as shelves, shelving supports and tool holders extending between opposing tubing receptacles.

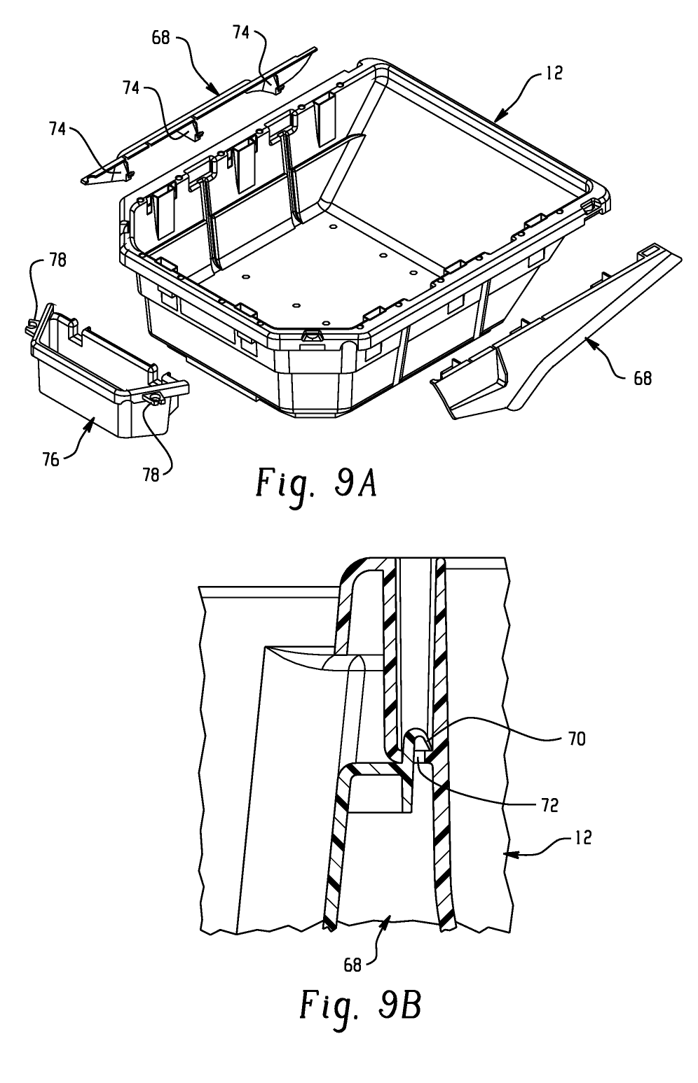

In a first alternate embodiment of cart 10 a set of fenders 68 may be removably attached to container 12, as shown in FIGS. 9A, 9B and 10. Fenders 68 are located proximate each wheel 16 and shaped to at least partially encircle the wheels. Fenders 68 may be attached to container 12 in any conventional manner, including fasteners such as screws, bolts and nuts. In one embodiment each fender 68 may be configured to snap in place, as generally depicted in FIGS. 9A and 9B. In this embodiment one or more resilient extensions 70 of fender 68 engage a corresponding fender receptacle 72 of container 12 by urging the resilient extension into the receptacle. Resilient extension 70 compresses to fit through receptacle 72, then expands after passing through the receptacle, thereby engaging the fender 68 to container 12. This provides a simple means to quickly and easily attach fenders 68 to container 12 without the need for tools. Fasteners such as screws (not shown) may optionally be installed through fenders 68 and into container 12 to provide additional support for the attachment of the fenders to the container.

Fenders 68 may be made from any suitable material for the stresses and environmental conditions expected for cart 10, and may include one or more strengthening ribs 74 (see FIGS. 3, 9A) on the undersides of the fenders to increase the strength and rigidity of the fenders. Example materials include, without limitation, plastic, metal and composites. Likewise, fenders 68 may be fabricated and assembled using any conventional processes, such as molding, machining, forming, welding, adhesives, fasteners, and composite lay-up. Fenders 68 may be finished in a color matching that of container 12, or may be a contrasting color. Further, the finish may be applied, such as paint, electroplated, or may be molded-in using a material having the desired color. Fenders 68 add utility to lawn and garden cart 10, for example, by preventing mud picked up by wheels 16 from being thrown upwardly. In addition, fenders 68 add novel aesthetic design features to lawn and garden cart 10. Various styles and shapes of fenders 68 may be utilized. A first non-limiting style is shown in FIG. 9A and a second non-limiting style is shown in FIG. 10.

In a second alternate embodiment of cart 10 a tool bin 76 may be removably attached to container 12, as depicted in FIGS. 9A and 10. Tool bin 76 may be used to hold tools or other small items. Tool bin 76 may be attached to container 12 in the same manner as fenders 68 (see FIG. 9B) using one or more resilient extensions 70 of the tool bin to engage a corresponding receptacle 72 of container 12, providing a simple means to quickly and easily attach the tool bin to container 12 without the need for tools. Fasteners such as screws (not shown) may optionally be installed through tool bin 76 and into container 12 to provide additional support for the attachment of the tool bin to the container.

Tool bin 76 may be fabricated, assembled and finished in the same manner as fenders 68. In some embodiments tool bin 76 may include one or more projecting members 78 (FIG. 10) that can be configured or shaped to detachably receive and hold tools and other small objects. Tool bin 76 adds utility to lawn and garden cart 10, for example, by providing a place to store and organize tools and other small objects. In addition, tool bin 76 adds novel aesthetic design features to lawn and garden cart 10.

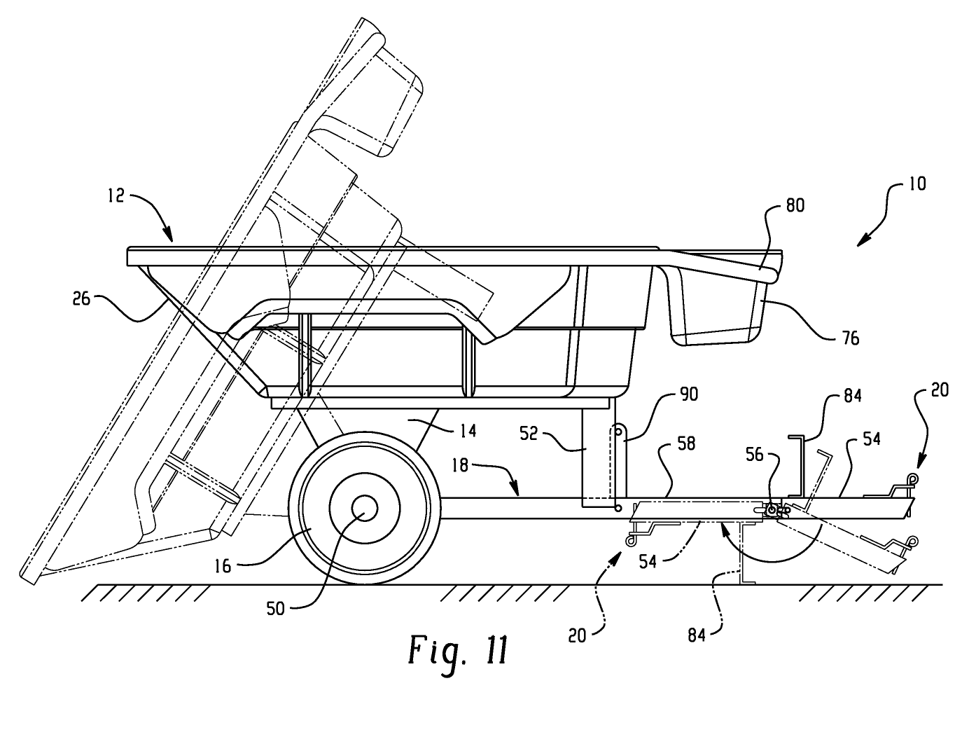

In a third alternate embodiment of cart 10 a handle 80 may be selectably coupled to a pair of handle connectors 82 of container 12, as shown in FIG. 3, to allow cart 10 to be manually moved about. Handle connectors 82 may be a molded-in feature of container 12, or may be fabricated separately and mounted to the container. Handle connectors 82 allow handle 80 to be quickly and easily attached or removed from container 12 without the need for tools. In some embodiments handle 80 may be configured to adjustably extend from container 12 at a plurality of selectable extended positions set by a plurality of apertures 86 in the handle, engaged by a biased stop 88 of handle connector 82. Handle 80 may be additionally stowed at least partially proximate container 12 as shown in FIG. 11.

Handle 80 may be made of metal, plastic or composite materials by any conventional processes, such as molding, machining and casting. Handle 80 may be finished in a color matching or contrasting with container 12, and may be finished by applying or electroplating a coating thereon, or may be provided with a molded-in color.

In the embodiment of FIG. 11 a pivot mechanism 56, such as a pin or hinge, may be operated to allow movable portion 54 of tow bar 18 to pivot from a stowed position generally aligned with fixed portion 58 to a deployed support position generally underneath the tow bar, where it is held in position by the weight of cart 10 and/or the pivot mechanism, as shown in FIG. 4. When at rest, a support member 84 of movable portion 54 is in contact with the ground to support cart 10. When cart 10 is to be moved, the user lifts upwardly on handle 80 (which may be in an extended or retracted position) such that support member 84 is not in contact with the ground and pushes or pulls on the handle. Cart 10 freely moves, being rotatably in contact with the ground only at wheels 16. If desired, the user may tip cart 10 backwardly such that angled rear wall 26 rests against the ground. This orientation facilitates loading and unloading of container 12 without the need to lift the load into or out of the container.

In a fourth alternate embodiment of the present invention connector 20 of tow bar 18 is coupled to a tractor, as shown in FIG. 12. A release mechanism 90 may be operated to release frame bracket 52 from tow bar 18. Release mechanism 90 may include a biased lever 92 that is configured to engage frame bracket 52 when not urged away to release the frame bracket from tow bar 18. When release mechanism 90 is operated to release frame bracket 52 the frame bracket is allowed to separate from tow bar 18, thereby allowing container 12 to pivot about axle 50 such that at least a portion of angled rear wall 26 rests against the ground, as shown in FIG. 12. Furthermore, if pivoting mechanism 56 is operated to allow movable portion 54 of tow bar 18 to pivot generally underneath container 12 in the manner previously described, support member 84 may remain in contact with the ground such that frame 14 is supported by the support member and wheels 16 while container 12 is pivoted (see FIG. 11).

In a fifth alternate embodiment of the present invention any or all of container 12, fenders 68, and tool bin 76 may be finished in a predetermined color or combination of colors and/or may include one or more images, logos and patterns. As a non-limiting example, a camouflage pattern 94 as in FIG. 13 may be utilized. The color or colors, image, logo and pattern may be applied in any conventional manner such as, without limitation, self-adhesive labels and brush, spray or dip painting using paints of one or more colors. Alternatively, any of the colors, images, logos and patterns may be molded-in. Likewise, canopy 69 may be finished in a predetermined color or combination of colors and/or may include one or more images, logos and patterns, including a camouflage pattern 94 as in FIG. 13. Canopy 69 may be finished in any conventional manner such as, without limitation, dyeing, printing, silk-screening, painting, molding and woven with various colors of thread or multi-color thread. It should be noted that any of the colors, images, logos and patterns utilized for container 12, fenders 68, canopy 69 and tool bin 76 may be any now known or hereafter created.

It should be noted that the devices and fasteners used to assemble together the various configurations and embodiments of cart 10 may be selected such that no tools are required for assembly. For example, bolts or screws having wing-shaped heads may be used cooperatively with nuts retained in mounting receptacles 48 of container 12, thereby facilitating assembly of the container to frame 14 without tools. The other components of cart 10 may likewise be assembled to the cart in a similar manner.

From the above description of the invention, those skilled in the art will perceive improvements, changes, and modifications in the invention. Such improvements, changes, and modifications within the skill of the art are intended to be covered. For example, cart 10 may include more than one of the above-discussed configurations, along with more than one embodiment. For example, a particular cart 10 may be configured to include both tool bin 76 and handle 80, and may further have stakes 66 installed in stake receptacles 36 and dividers in divider slots 32. The various features, configurations and alternate embodiments, singly and in various combinations, are contemplated by the present invention.

What is claimed is:

1. A lawn and garden cart, comprising:
a frame;
an axle attached to the frame and having a pair of opposing ends;
a pair of wheels, each wheel being rotatably attached to an opposing end of the axle;
a longitudinal tow bar attached to the frame at a first end, the tow bar including a connector at a second distal end; and
a container having a base, a plurality of generally vertical sidewalls and an angled rear wall, the container being pivotally attached to the frame and releasably coupled to the tow bar.

2. The lawn and garden cart of claim 1 wherein the container further includes an integral shelf ledge formed in the vertical sidewalls and configured to receive a removable shelf.

3. The lawn and garden cart of claim 1 wherein the container further includes a plurality of integral, opposing board ledges formed in the vertical sidewalls and configured to receive at least one removable board.

4. The lawn and garden cart of claim 1 wherein the container further includes a plurality of integral, opposing divider slots formed in the vertical sidewalls and configured to receive at least one removable divider panel.

5. The lawn and garden cart of claim 1 wherein the container further includes a plurality of integral stake receptacles formed in the vertical sidewalls and configured to receive at least one removable stake.

6. The lawn and garden cart of claim 1 wherein at least one vertical sidewall of the container further includes an integral tie-down receptacle formed therein.

7. The lawn and garden cart of claim 1 wherein the container further includes a plurality of integral tubing receptacles formed in the vertical sidewalls.

8. The lawn and garden cart of claim 7, further comprising at least one accessory having a tubular-shaped connector, the accessory being configured to be removably inserted into the tubing receptacles.

9. The lawn and garden cart of claim 7, further comprising a framework of tubing and a canopy, the tubing configured to be removably inserted into the tubing receptacles and the canopy being configured to be removably installed over the framework.

10. The lawn and garden cart of claim 9 wherein the canopy further includes at least one of a predetermined color, color combination, image, logo and pattern.

11. The lawn and garden cart of claim 10 wherein the canopy is finished in a camouflage pattern.

12. The lawn and garden cart of claim 1 wherein the container further includes at least one strengthening rib integrally formed in a bottom portion thereof.

13. The lawn and garden cart of claim 1 wherein the container further includes a fender proximate each wheel.

14. The lawn and garden cart of claim 13 wherein at least one of the container and fender includes at least one of a predetermined color, color combination, image, logo and pattern.

15. The lawn and garden cart of claim 1 wherein the container further includes a tool bin attached thereto.

16. The lawn and garden cart of claim 15 wherein at least one of the container and tool bin includes at least one of a predetermined color, color combination, image, logo and pattern.

17. The lawn and garden cart of claim 1 wherein the container further includes a handle attached thereto.

18. The lawn and garden cart of claim 17 wherein the handle is selectably positionable between a stowed position and an extended position.

19. The lawn and garden cart of claim 1 wherein the container is selectably positionable with respect to a surface beneath the cart, between:
a first orientation wherein the base of the container is generally parallel with the surface, and
a second orientation wherein the angled rear wall is in contact with the surface.

20. The lawn and garden cart of claim 1 wherein the tow bar further includes a movable portion proximate the second end of the tow bar, the movable portion having a support member and being selectably positionable between a first stowed position and a second deployed support position.

21. The lawn and garden cart of claim 1 wherein the container further includes a plurality of integral mounting receptacles formed in the base of the container to facilitate the installation of fasteners therethrough to attach the container to the frame, the mounting receptacles being shaped to be engaged by the fasteners.

22. The lawn and garden cart of claim 1 wherein the container includes at least one of a predetermined color, color combination, image, logo and pattern.

23. A lawn and garden cart, comprising:
a frame;
an axle attached to the frame and having a pair of opposing ends;
a pair of wheels, each wheel being rotatably attached to an opposing end of the axle;
a longitudinal tow bar attached to the frame at a first end, the tow bar including a connector at a second distal end and a movable portion proximate the second end, the movable portion having a support member and being selectably positionable between a first stowed position and a second deployed support position;
a container having a base, a plurality of generally vertical sidewalls and an angled rear wall, the container further comprising at least one of: an integral shelf ledge; integral, opposing board ledges; integral, opposing divider slots; integral stake receptacles; an integral tie-down receptacle; and integral tubing receptacles,
wherein the container is pivotally attached to the frame and is releasably coupled to the tow bar, and
wherein the container is selectably positionable with respect to a surface beneath the cart between a first orientation wherein the base of the container is generally parallel with the surface and a second orientation wherein the angled rear wall is in contact with the surface.

24. The lawn and garden cart of claim 23 wherein the container further includes a fender proximate each wheel.

25. The lawn and garden cart of claim 23 wherein the container further includes a tool bin coupled thereto.

26. The lawn and garden cart of claim 23 wherein the container further includes a handle attached thereto, the handle being selectably positionable between a stowed position and an extended position.

27. A lawn and garden cart, comprising:
a frame;
an axle attached to the frame and having a pair of opposing ends;
a pair of wheels, each wheel being rotatably attached to an opposing end of the axle;
a longitudinal tow bar attached to the frame at a first end, the tow bar including a connector at a second distal end and a movable portion proximate the second end, the movable portion having a support member and being selectably positionable between a first stowed position and a second deployed support position;
a container having a base, a plurality of generally vertical sidewalls and an angled rear wall, the container further comprising at least one of: an integral shelf ledge; integral, opposing board ledges; integral, opposing divider slots; integral stake receptacles; an integral tie-down receptacle; integral tubing receptacles; a fender proximate each wheel; a tool bin coupled thereto, and a handle attached thereto, the handle being selectably positionable between a stowed position and an extended position,
wherein the container is pivotally attached to the frame and is releasably coupled to the tow bar, and
wherein the container is selectably positionable with respect to a surface beneath the cart, between a first orientation wherein the base of the container is generally parallel with the surface, and a second orientation wherein the angled rear wall is in contact with the surface.
